(19) United States
(12) Patent Application Publication
(10) Pub. No.: US 2024/0288533 A1
(43) Pub. Date: Aug. 29, 2024

(54) RADAR APPARATUS AND INTERFERENCE WAVE SUPPRESSION DEVICE

(71) Applicant: Mitsubishi Electric Corporation, Tokyo (JP)

(72) Inventor: Tatsuya KAMIMURA, Tokyo (JP)

(73) Assignee: Mitsubishi Electric Corporation, Tokyo (JP)

(21) Appl. No.: 18/570,646

(22) PCT Filed: Jun. 21, 2021
(86) PCT No.: PCT/JP2021/023374

§ 371 Date: Dec. 15, 2023

(51) Int. Cl. G01S 7/02; G01S 7/35; G01S 13/36

(52) U.S. Cl. CPC G01S 7/0232; G01S 7/354; G01S 13/36

(57) ABSTRACT

A radar apparatus includes a transceiver and an interference wave suppression device. The transceiver outputs a transmission wave that is frequency-modulated. The transceiver receives a reflected wave propagated by reflection of the transmission wave from a target, and outputs a reception signal. The interference wave suppression device separates, when an interference wave is received together with the reflected wave, a noise signal derived from the interference wave from the reception signal and suppresses the noise signal, the interference wave being a radio wave other than the reflected wave and being frequency-modulated in a mode different from a mode of the transmission wave.

### FIELD

The present disclosure relates to a radar apparatus that detects a target using a transmission wave that is frequency-modulated, and to an interference wave suppression device.

### BACKGROUND

As sensors installed in vehicles, Frequency Modulated Continuous Wave (FMCW) radars and Fast Chirp Modulation (FCM) radars are becoming widespread. Such a FMCW radar has characteristics such that a circuit configuration is simple, and signal processing is easy because a frequency band of a reception beat signal is relatively low. The FMCW radar performs an up-chirp for increasing a frequency of a transmission wave and a down-chirp for decreasing the frequency of the transmission wave, and obtains reception beat signals based on the up-chirp and the down-chirp. The FMCW radar calculates a distance to a target, a relative velocity of the target, an azimuth angle of the target, and the like, based on a difference in frequencies in the reception beat signals. On the other hand, such a FCM radar performs one of the up-chirp and the down-chirp to obtain a reception beat signal. The FCM radar calculates a distance to a target, a relative velocity of the target, an azimuth angle of the target, and the like, based on a frequency and phase information of the reception beat signal. The FCM radar can be made lower in signal processing load than the FMCW radar because of the unnecessity of pairing the up-chirp with the down-chirp. In the following description, in a case where the FMCW radar and the FCM radar are not distinguished, they are referred to as a “radar” or a “radar apparatus”.

Patent Literature 1 discloses a technique that relates to a frequency modulation circuit installed in the FMCW radar and that is for obtaining high linearity of frequency modulation.

### CITATION LIST

### Patent Literature

Patent Literature 1: Japanese Patent No. 6351910

### SUMMARY OF INVENTION

### Problem to be Solved by the Invention

With the widespread use of such radars, radars installed in vehicles are more likely to receive not only a reflected wave propagated by reflection of a transmission wave from a target, but also an interference wave that is a radio wave emitted from a radar of another vehicle.

In a radar apparatus disclosed in Patent Literature 1, signal processing is sometimes performed in a state in which a noise signal derived from an interference wave is superimposed on a reception beat signal derived from a reflected wave from a target. A decrease in a Signal to Noise Ratio (SNR) of the reception beat signal due to the superimposition of the noise signal results in deterioration of detection performance of the radar apparatus. The radar apparatus disclosed in Patent Literature 1 involves difficulty in stably detecting the target with high accuracy because its detection performance sometimes deteriorates owing to reception of the interference wave. Such difficulty is problematic.

The present disclosure has been made in view of the above, and an object of the present disclosure is to provide a radar apparatus capable of stably detecting a target with high accuracy.

### Means to Solve the Problem

In order to solve the above-described problem and achieve the object, a radar apparatus of the present disclosure includes: a transceiver to output a transmission wave that is frequency-modulated, and to receive a reflected wave propagated by reflection of the transmission wave from a target and to output a reception signal; and an interference wave suppression device to separate, when an interference wave is received together with the reflected wave, a noise signal derived from the interference wave from the reception signal and to suppress the noise signal, the interference wave being a radio wave other than the reflected wave and being frequency-modulated in a mode different from a mode of the transmission wave.

### Effects of the Invention

The radar apparatus according to the present disclosure has an effect capable of stably detecting the target with high accuracy.

### BRIEF DESCRIPTION OF DRAWINGS

FIG. 1 is a diagram illustrating a configuration of a radar apparatus according to a first embodiment.

FIG. 2 is a diagram illustrating details of a Micro Control Unit (MCU) included in the radar apparatus according to the first embodiment.

FIG. 3 is a diagram illustrating an example of a hardware configuration of the MCU included in the radar apparatus according to the first embodiment.

FIG. 4 is an explanatory diagram illustrating a modulated signal generated by a local unit of the radar apparatus according to the first embodiment.

FIG. 5 is a diagram illustrating an example of a time-frequency characteristic of each of a transmission wave, a received desired wave, and a received interference wave in the first embodiment.

FIG. 6 is a diagram illustrating an example of a frequency modulation characteristic of each of the transmission wave, the received desired wave, and the received interference wave in the first embodiment.

FIG. 7 is an explanatory diagram illustrating changes in frequencies of the received desired wave and the received interference wave in the first embodiment.

FIG. 8 is a first diagram illustrating an example of waveforms of reception beat signals in a case where a desired wave and an interference wave are simultaneously received in the first embodiment.

FIG. 9 is a second diagram illustrating an example of the waveforms of the reception beat signals in the case where the desired wave and the interference wave are simultaneously received in the first embodiment.

FIG. 10 is a third diagram illustrating an example of the waveforms of the reception beat signals in the case where the desired wave and the interference wave are simultaneously received in the first embodiment.

FIG. 11 is an explanatory diagram illustrating an interference wave suppression effect of an interference wave suppression device according to the first embodiment.

### DESCRIPTION OF EMBODIMENTS

Hereinafter, a radar apparatus and an interference wave suppression device according to an embodiment will be described in detail with reference to the drawings.

### First Embodiment

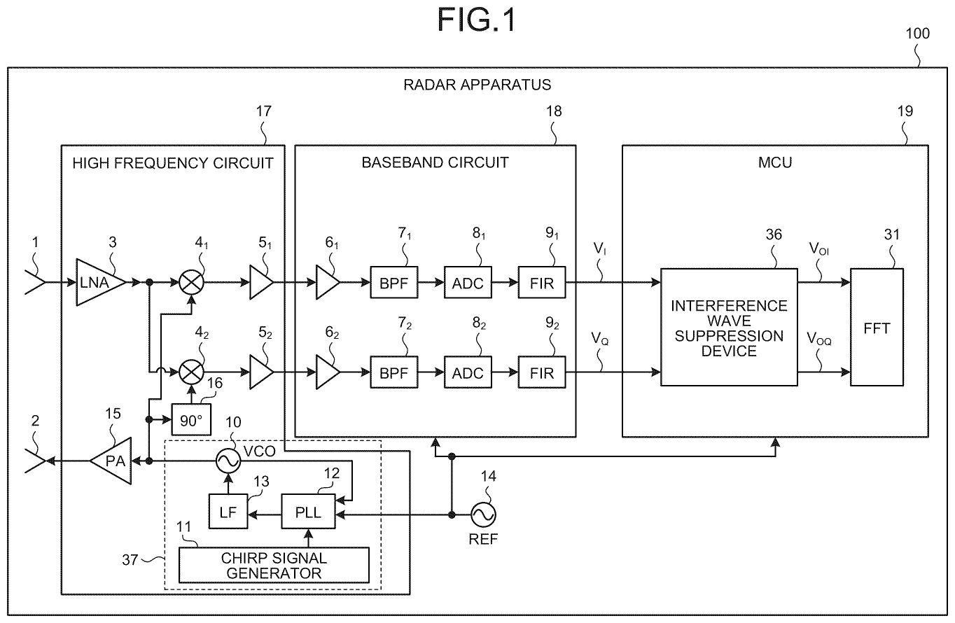

FIG. 1 is a diagram illustrating a configuration of a radar apparatus 100 according to a first embodiment. The radar apparatus 100 is installed in a vehicle. The radar apparatus 100 includes a reception antenna 1 and a transmission antenna 2 that constitute an antenna unit, a reference signal source 14 that generates a reference signal REF (REFerence signal), a high frequency circuit 17, a baseband circuit 18, and a Micro Control Unit (MCU) 19. The reference signal source 14, the high frequency circuit 17, and the baseband circuit 18 constitute a transceiver of the radar apparatus 100. The MCU 19 constitutes a signal processing unit of the radar apparatus 100.

The radar apparatus 100 illustrated in FIG. 1 is a radar including one reception channel and one transmission channel. The channel denotes a group of processing units including components of the transceiver and the signal processing unit that are processed by one reception antenna 1 or one transmission antenna 2. Note that, the number of reception channels and the number of transmission channels in the radar apparatus 100 can each be any number.

The high frequency circuit 17 outputs, via the transmission antenna 2, a transmission wave that is frequency-modulated. Additionally, the high frequency circuit 17 receives, via the reception antenna 1, a reflected wave propagated by reflection of the transmission wave from a target, and outputs a reception signal.

The high frequency circuit 17 includes a Voltage Controlled Oscillator (VCO) 10, a chirp signal generator 11 that generates a chirp signal, a Phase Locked Loop (PLL) 12, and a Loop Filter (LF) 13. The VCO 10, the chirp signal generator 11, the PLL 12, and the LF 13 constitute a local unit 37. The local unit 37 generates a modulated signal that is a frequency-modulated signal. In the following description, the modulated signal generated by the local unit 37 is also referred to as a local signal.

The reference signal REF and the chirp signal are input to the PLL 12. The PLL 12 frequency-modulates the reference signal REF with a modulation pattern based on the chirp signal. The signal frequency-modulated by the PLL 12 is band-limited by the LF 13 and input to the VCO 10. The VCO 10 outputs a high-frequency signal that is the modulated signal in cooperation with the PLL 12.

Additionally, the high frequency circuit 17 includes a Low Noise Amplifier (LNA) 3, MIXers (MIXs) 4₁ and 4₂, Intermediate Frequency Amplifiers (IFAs) 5₁ and 5₂, a Power Amplifier (PA) 15, and a phase shifter 16. The PA 15 amplifies the high-frequency signal output from the VCO 10 to a desired power level. The transmission antenna 2 converts the high-frequency signal output from the PA 15 into a transmission wave that is a radio wave, and emits the transmission wave into space.

The reception antenna 1 receives a reflected wave propagated by reflection of the transmission wave from a target, and converts the reflected wave into a reception signal. The LNA 3 amplifies the reception signal to a desired power level. The MIXs 4₁ and 4₂ each down-convert the reception signal by frequency conversion using the local signal. The MIXs 4₁ and 4₂ each reduce a frequency of the reception signal to a frequency of an Intermediate Frequency (IF) band by the down-conversion. The MIXs 4₁ and 4₂ output reception beat signals derived from the down-converted reception signal. The IFAs 5₁ and 5₂ amplify the reception beat signals to desired signal strength. The phase shifter 16 changes a phase of the reception beat signal output from the MIX 4₂ by 90 degrees. Thus, the high frequency circuit 17 outputs, from the IFAs 5₁ and 5₂, a first reception beat signal and a second reception beat signal that are two reception beat signals having phases different from each other by 90 degrees. In the following description, the first reception beat signal and the second reception beat signal are also referred to as quadrature reception beat signals.

The baseband circuit 18 converts the quadrature reception beat signals output from the high frequency circuit 17 into baseband signals having digital values. The baseband circuit 18 includes Base Band Amplifiers (BBAs) 6₁ and 6₂, Band Pass Filters (BPFs) 7₁ and 7₂, Analog to Digital Converters (ADCs) 8₁ and 8₂, and Finite Impulse Response (FIR) filters 9₁ and 9₂.

The BBAs 6₁ and 6₂ amplify the quadrature reception beat signals output from the high frequency circuit 17 to desired voltage strength. The BPFs 7₁ and 7₂ limit bands of the signals amplified by the BBAs 6₁ and 6₂. The ADCs 8₁ and 8₂ convert analog signals output from the BPFs 7₁ and 7₂ into digital signals. The FIR filters 9₁ and 9₂ limit the bands of the signals output from the ADCs 8₁ and 8₂. The baseband circuit 18 outputs V₁ and V_{Q} that represent the quadrature reception beat signals having been processed by the BBAs 6₁ and 6₂, the BPFs 7₁ and 7₂, the ADCs 8₁ and 8₂, and the FIR filters 9₁ and 9₂.

The MCU 19 includes a Fast Fourier Transform (FFT) processing unit 31 and an interference wave suppression device 36. When an interference wave that is a radio wave other than the reflected wave is received together with the reflected wave, the interference wave suppression device 36 separates a noise signal derived from the interference wave from the reception signal and suppresses the noise signal. The interference wave is a radio wave that is frequency-modulated in a mode different from that of the transmission wave emitted by the radar apparatus 100, the radio wave being emitted from a radar of another vehicle.

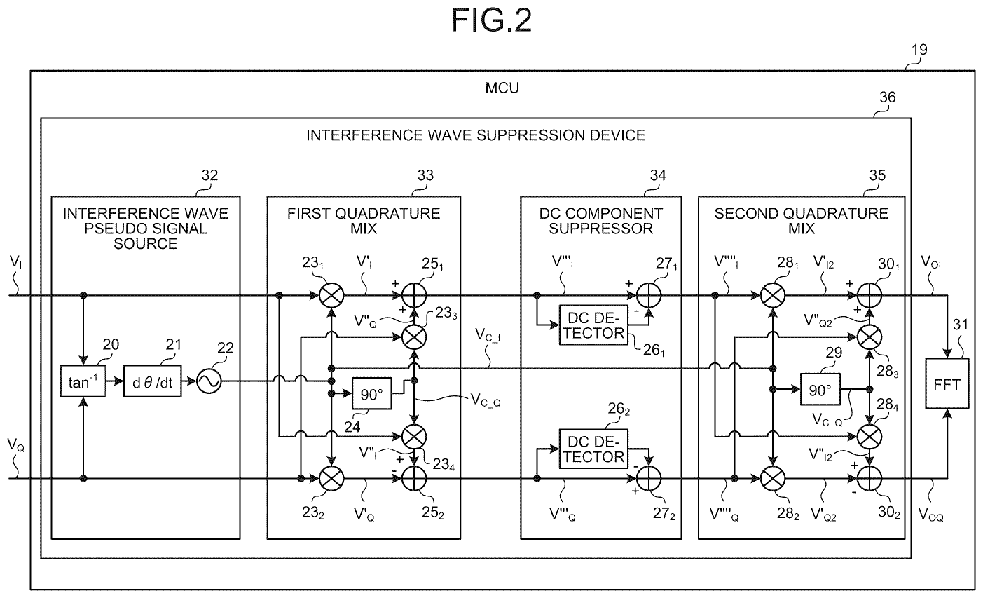

FIG. 2 is a diagram illustrating details of the MCU 19 included in the radar apparatus 100 according to the first embodiment. The interference wave suppression device 36 includes an interference wave pseudo signal source 32, a first quadrature MIXer (MIX) 33, a Direct Current (DC) component suppressor 34, and a second quadrature MIXer (MIX) 35. The interference wave suppression device 36 performs processing for suppressing a noise signal derived from an interference wave, based on the quadrature reception beat signals output from the baseband circuit 18.

The interference wave pseudo signal source 32 generates a pseudo signal of the interference wave based on the first reception beat signal and the second reception beat signal in the case where the reflected wave and the interference wave are simultaneously received. The interference wave pseudo signal source 32 includes an instantaneous phase detector 20, an instantaneous frequency detector 21, and an interference wave pseudo signal generator 22.

The instantaneous phase detector 20 detects an instantaneous phase of the noise signal derived from the interference wave, based on the quadrature reception beat signals. The instantaneous frequency detector 21 detects an instantaneous frequency of the noise signal derived from the interference wave, based on the detected instantaneous phase. The instantaneous phase detector 20 and the instantaneous frequency detector 21 convert the quadrature reception beat signals into data representing a time and frequency characteristic of the noise signal. In the following description, the time and frequency characteristic is referred to as a time-frequency characteristic. The interference wave pseudo signal generator 22 generates the pseudo signal of the interference wave based on the data representing the time-frequency characteristic of the noise signal. The interference wave pseudo signal generator 22 outputs VW that represents the pseudo signal of the interference wave.

The first quadrature MIX 33 performs frequency conversion on each of the first reception beat signal and the second reception beat signal based on the pseudo signal of the interference wave, and suppresses a time variation component of the noise signal. The first quadrature MIX 33 separates the noise signal derived from the interference wave from the quadrature reception beat signals by suppressing the time variation component of the noise signal. The first quadrature MIX 33 includes MIXers (MIXs) 23₁, 23₂, 23₃, and 23₄, a phase shifter 24, and adders 25₁ and 25₂. The phase shifter 24 changes a phase of VW, by 90 degrees to output V_{C_Q} that represents a pseudo signal having a phase different from that of V_{C_I} by 90 degrees. Through the separation of the noise signal in the first quadrature MIX 33, the interference wave suppression device 36 suppresses only the noise signal derived from the interference wave.

The DC component suppressor 34 detects an unnecessary DC component generated in the first quadrature MIX 33, and suppresses the detected DC component. The DC component suppressor 34 includes DC detectors 26₁ and 26₂. and adders 27₁ and 27₂.

In the first quadrature MIX 33, the reception beat signals are multiplied by the pseudo signals of the interference wave. The second quadrature MIX 35 performs frequency conversion on each of the first reception beat signal and the second reception beat signal based on the pseudo signals, and removes the pseudo signals by which the first reception beat signal and the second reception beat signal are multiplied in the first quadrature MIX 33. The second quadrature MIX 35 includes MIXs 28₁, 28₂, 28₃, and 28₄, a phase shifter 29, and adders 30₁, and 30₂. The phase shifter 29 changes a phase of V_{C_I} by 90 degrees to output V_{C_Q}. that represents a pseudo signal having a phase different from that of V_{C_I} by 90 degrees. The interference wave suppression device 36 outputs the quadrature reception beat signals from which the pseudo signals of the interference wave have been removed by the second quadrature MIX 35.

The FFT processing unit 31 performs fast Fourier transform on the quadrature reception beat signals output from the interference wave suppression device 36. The FFT processing unit 31 executes radar signal processing in accordance with the fast Fourier transform to calculate a distance to the target, a relative velocity of the target, an azimuth angle of the target, and the like. The distance to the target is the distance between the vehicle and the target. The relative velocity is the velocity of the target viewed from the vehicle. The azimuth angle is the angle representing the azimuth of the target with reference to the vehicle.

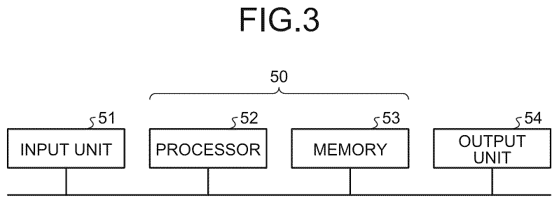

A hardware configuration of the MCU 19 will now be described. FIG. 3 is a diagram illustrating an example of the hardware configuration of the MCU 19 included in the radar apparatus 100 according to the first embodiment. The FFT processing unit 31 and the interference wave suppression device 36 of the MCU 19 are implemented by using processing circuitry 50. The processing circuitry 50 includes a processor 52 and a memory 53.

The processor 52 is a Central Processing Unit (CPU). The processor 52 may be an arithmetic unit, a microprocessor, a microcomputer, or a Digital Signal Processor (DSP). The memory 53 is, for example, a Random Access Memory (RAM), a Read Only Memory (ROM), a flash memory, an Erasable Programmable Read Only Memory (EPROM), an Electrically Erasable Programmable Read Only Memory (EEPROM; registered trademark), or the like.

The memory 53 stores a program for operation as a signal processing unit including the FFT processing unit 31 and the interference wave suppression device 36. The function of the signal processing unit can be implemented by the processor 52 reading and executing the program.

An input unit 51 is a circuit that receives an input signal to the MCU 19 from the outside of the MCU 19. The quadrature reception beat signals output from the baseband circuit 18 and the reference signal REF output from the reference signal source 14 are input to the input unit 51. An output unit 54 is a circuit that outputs a signal generated by the MCU 19 to the outside of the MCU 19. The output unit 54 outputs results of calculating the distance to the target, the relative velocity of the target, the azimuth angle of the target, and the like in the FFT processing unit 31.

Although the configuration illustrated in FIG. 3 is an example of hardware in a case where the signal processing unit of the radar apparatus 100 is implemented by the general-purpose processor 52 and the memory 53, the signal processing unit of the radar apparatus 100 may be implemented by a dedicated processing circuitry instead of the processor 52 and the memory 53. The dedicated processing circuitry is a single circuit, a composite circuit, an Application Specific Integrated Circuit (ASIC), a Field Programmable Gate Array (FPGA), or a circuit obtained by combining these circuits. Note that, a part of the signal processing unit may be implemented by the processor 52 and the memory 53, and the remaining part may be implemented by the dedicated processing circuitry.

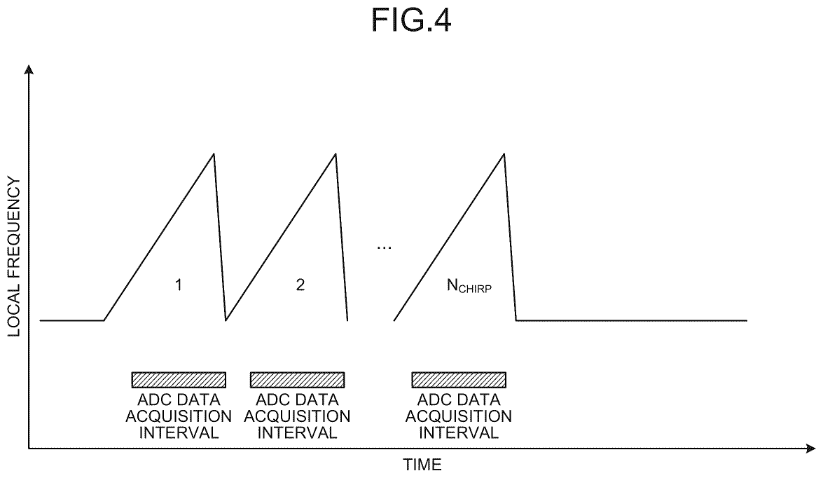

The modulated signal generated by the radar apparatus 100 will now be described. FIG. 4 is an explanatory diagram illustrating the modulated signal generated by the local unit 37 of the radar apparatus 100 according to the first embodiment. FIG. 4 illustrates, in a graph, a time-frequency characteristic of the modulated signal. In the graph, a horizontal axis represents time, and a vertical axis represents a frequency.

FIG. 4 illustrates an example of a waveform of the modulated signal that is an up-chirp signal. The up-chirp signal is a signal whose frequency increases at a constant slope with respect to time. The modulated signal generated by the local unit 37 is a FCM signal represented by a sawtooth wave. The number of triangular waveforms included in the sawtooth wave is N_{CHIRP} in total. The number of triangular waveforms included in the sawtooth wave can be any number. A width of each of the triangular waveforms in a horizontal axis direction represents a frequency modulation cycle. A width of each of the triangular waveforms in a vertical axis direction represents a frequency modulation bandwidth. In the following description, the slope of the graph indicated by the triangular waveform is referred to as a modulation slope. Note that, the modulated signal generated by the local unit 37 may be a down-chirp signal. The down-chirp signal is a signal whose frequency decreases at a constant slope with respect to time.

Furthermore, an interval indicated by hatching in FIG. 4 is an ADC data acquisition interval. The ADC data acquisition interval is an operation period of the ADCs 8; and 8₂ in one cycle of the modulated signal, the operation period being a period in which digital data is acquired by conversion in the ADCs 8₁ and 8₂.

The reflected wave and interference wave received by the radar apparatus 100 will next be described. In the following description, a reflected wave from a target is referred to as a desired wave. Additionally, the desired wave received by the reception antenna 1 is referred to as a received desired wave, and the interference wave received by the reception antenna 1 is referred to as a received interference wave.

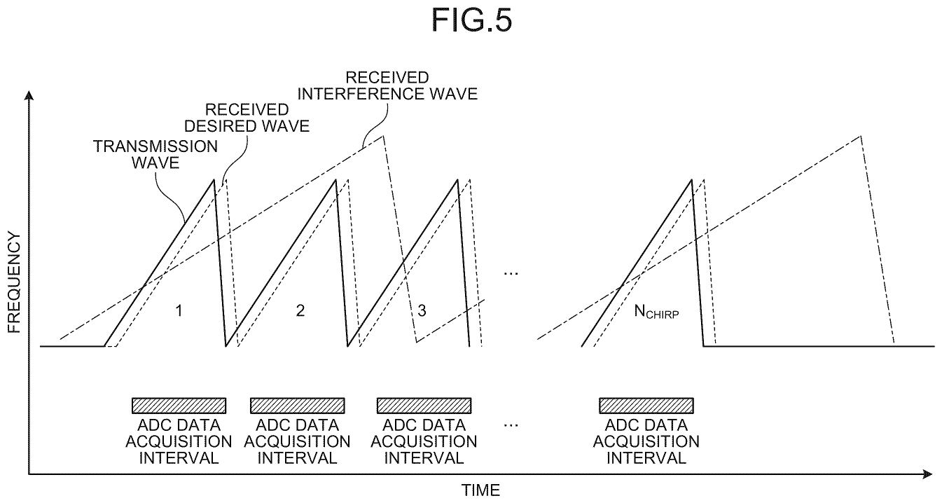

FIG. 5 is a diagram illustrating an example of a time-frequency characteristic of each of the transmission wave, the received desired wave, and the received interference wave in the first embodiment. The time-frequency characteristic of the transmission wave is the same as the time-frequency characteristic of the modulated signal illustrated in FIG. 4. The desired wave is received with a delay from the transmission of the transmission wave. A delay time of the received desired wave from the transmission wave corresponds to a time obtained by adding a time in which the transmission wave propagates from the transmission antenna 2 to the target and a time in which the desired wave propagates from the target to the reception antenna 1. The modulation cycle, the modulation bandwidth, and the modulation slope of the received desired wave are the same as the modulation cycle, the modulation bandwidth, and the modulation slope of the transmission wave, respectively.

The received interference wave is a radio wave transmitted from another vehicle. All of the modulation cycle, the modulation bandwidth, and the modulation slope of the received interference wave are different from the modulation cycle, the modulation bandwidth, and the modulation slope of the transmission wave, respectively. Note that, although FIG. 5 illustrates an example in which the received interference wave is the FCM signal that is the up-chirp, a FCM signal that is the down-chirp or a FMCW signal can also be the received interference wave.

Description will next be given of the quadrature reception beat signals generated in a case where the desired wave and the interference wave are simultaneously received. When the desired wave and the interference wave are simultaneously received, the high frequency circuit 17 and the baseband circuit 18 generate quadrature reception beat signals based on the received desired wave and the received interference wave.

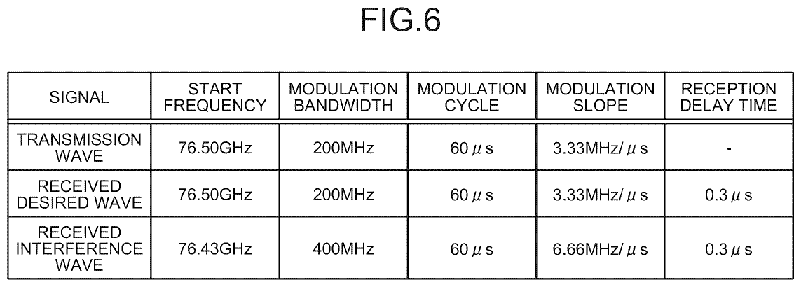

FIG. 6 is a diagram illustrating an example of a frequency modulation characteristic of each of the transmission wave, the received desired wave, and the received interference wave in the first embodiment. A start frequency illustrated in FIG. 6 is a frequency at a start of the modulation cycle. A reception delay time corresponds to a time from the transmission of a transmission wave from the transmission antenna 2 to the reception of a desired wave or an interference wave at the reception antenna 1. Each of the transmission wave, the received desired wave, and the received interference wave illustrated in FIG. 6 is a FCM signal.

In a case where the difference between the frequency of the local signal that is a basis of the transmission wave and the frequency of the interference wave matches the frequency in the IF band, the noise signal derived from the received interference wave is superimposed on the reception beat signal derived from the received desired wave. The SNR of the reception beat signal derived from the received desired wave decreases owing to the superimposition of the noise signal. In this case, the detection performance of the radar apparatus 100 deteriorates.

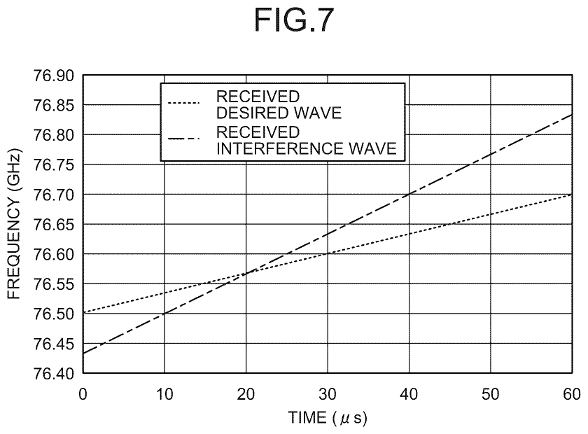

FIG. 7 is an explanatory diagram illustrating changes in frequencies of the received desired wave and the received interference wave in the first embodiment. FIG. 7 illustrates, in a graph, a relationship between the frequencies and time of the received desired wave and the received interference wave in the modulation cycle. In the graph, a horizontal axis represents time, and a vertical axis represents a frequency. Note that, since the reception delay time of the received desired wave is 0.3 μs, if the transmission wave is illustrated in the graph of FIG. 7, the graph illustrating the transmission wave overlaps with the graph illustrating the received desired wave. Thus, the graph illustrating the transmission wave is omitted in FIG. 7.

The frequency of the received desired wave and the frequency of the received interference wave are the same at about 20 μs. At about 20 μs, the frequency of the reception beat signal derived from the received interference wave is down-converted to the frequency in the IF band in the radar apparatus 100. As a result, the reception beat signal derived from the received interference wave is superimposed on the reception beat signal derived from the received desired wave, which results in a decrease in the SNR of the reception beat signal derived from the received desired wave.

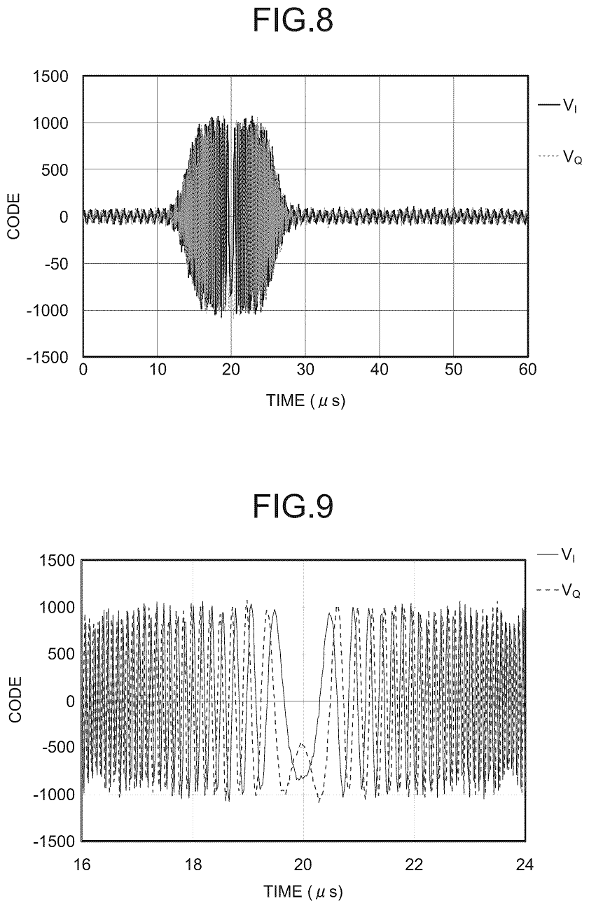

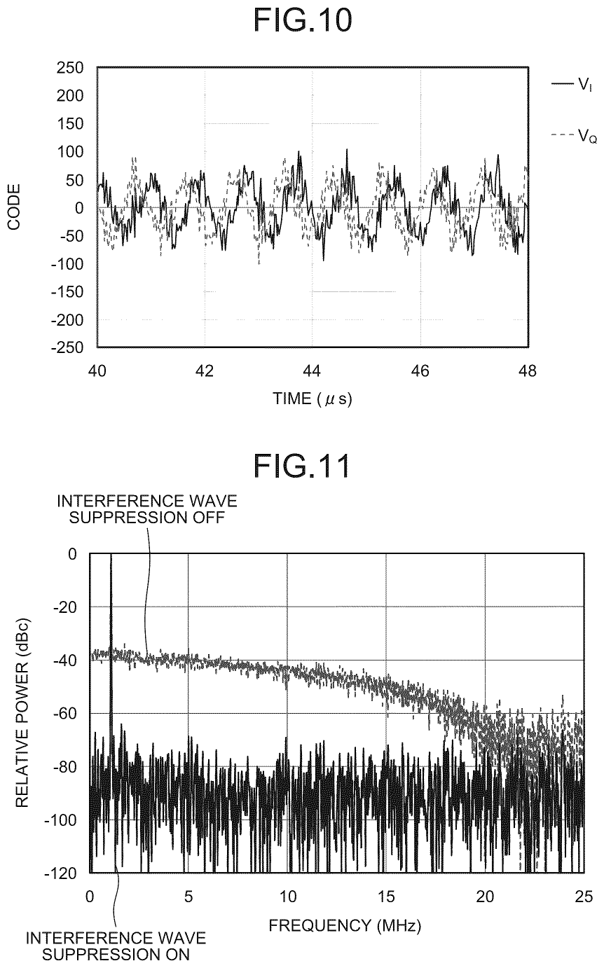

FIG. 8 is a first diagram illustrating an example of the waveforms of the reception beat signals in the case where the desired wave and the interference wave are simultaneously received in the first embodiment. FIG. 9 is a second diagram illustrating an example of the waveforms of the reception beat signals in the case where the desired wave and the interference wave are simultaneously received in the first embodiment. FIG. 10 is a third diagram illustrating an example of the waveforms of the reception beat signals in the case where the desired wave and the interference wave are simultaneously received in the first embodiment.

V_{I} and V_{Q} represent the first reception beat signal and the second reception beat signal output from the baseband circuit 18, that is, the quadrature reception beat signals. FIG. 8 illustrates an example of time waveforms of V_{I} and V_{Q} in a time period of 0 μs to 60 μs that is the modulation cycle. FIG. 9 illustrates the time waveforms that are in the time period of 16 μs to 24 μs out of the time waveforms illustrated in FIG. 8 and that are enlarged in a direction of a time axis. FIG. 10 illustrates the time waveforms that are in the time period of 40 μs to 48 μs out of the time waveforms illustrated in FIG. 8 and that are enlarged in a direction of a time axis. In FIGS. 8, 9, and 10, “CODE” represented by a vertical axis represents the digital values output from the ADCs 8₁ and 8₂ In FIGS. 8, 9, and 10, a horizontal axis represents the time axis.

As can be seen in FIGS. 8 to 10, at about 20 μs, the reception beat signal derived from the received interference wave is dominant. Whether the reception beat signal derived from the received interference wave is dominant is determined based on the frequencies of the quadrature reception beat signals. The frequency of each of V_{I} and V_{Q} approaches 0 at about 20 μs where there is an intersection of a curve indicating the time waveform of V_{I} and a curve indicating the time waveform of V_{Q} in FIG. 9. Since the frequency of each of V_{I} and V_{Q} changes in the case of around 20 μs along the time axis, at about 20 μs, the reception beat signal derived from the received interference wave is dominant. On the other hand, in FIG. 10, since the frequency of each of V_{I} and V_{Q} is constant, in the time period of 40 μs to 48 μs, the reception beat signal derived from the received desired wave is dominant. At about 20 μs, the noise signal derived from the received interference wave has energy in the entire frequency region of the IF band of the radar apparatus 100. For this reason, in the conventional radar in which the interference wave is not suppressed, when the desired wave and the interference wave are simultaneously received, the SNR of the reception beat signal derived from the received desired wave decreases.

Specific operation of the interference wave suppression device 36 will next be described. In a case where the reception antenna 1 simultaneously receives one type of desired wave and one type of interference wave, V_{I} and V_{Q} that represent the reception beat signals are respectively expressed as the following formulas (1) and (2).

$$Formula 1 :$$

$${V}_{i} = A ( t ) \times sin ( \int {ω}_{IR} ( τ ) d τ ) + B \times sin ( \int {ω}_{B} ( τ ) d τ ) \qquad ( 1 )$$

$$Formula 2 :$$

$${V}_{Q} = A ( t ) \times cos ( \int {ω}_{IR} ( τ ) d τ ) + B \times sin ( \int {ω}_{B} ( τ ) d τ ) \qquad ( 2 )$$

ω_{IR} represents an angular frequency of the reception beat signal down-converted to the frequency in the IF band and derived from the received interference wave. That is, raj is an angular frequency of the noise signal. ω_{B} represents an angular frequency of the reception beat signal down-converted to the frequency in the IF band and derived from the received desired wave. In formulas (1) and (2), the first term represents the noise signal, and the second term represents the reception beat signal derived from the received desired wave. In the BPFs 7₁ and 7₂ of the baseband circuit 18, since the amplitude of the noise signal is limited by the frequency, the frequency of the noise signal varies with time. Thus, in formulas (1) and (2), the amplitude of the noise signal is represented by A(t) that is a time function. B represents the amplitude of the reception beat signal derived from the received desired wave.

Specific operation of the interference wave pseudo signal source 32 will now be described. The interference wave pseudo signal source 32 generates the pseudo signal of the interference wave by converting the noise signal into data representing the time-frequency characteristic and performing linear approximation of the data representing the time-frequency characteristic. V_{C_I} representing the pseudo signal output from the interference wave pseudo signal source 32 is expressed as the following formula (3). V_{C_Q} representing the pseudo signal obtained by changing the phase of V_{C_I} by 90 degrees is expressed as the following formula (4).

$$Formula 3 :$$

$${V}_{C \_ I} = C \times sin ( ( 2 π ) \int {f}_{c} ( τ ) d τ ) = C \times sin \{ ( 2 π ) ( \frac{1}{2} {α}_{C} \times {t}^{2} + {β}_{C} \times t + {φ}_{C} ) \} \qquad ( 3 )$$

$$Formula 4 :$$

$${V}_{C \_ Q} = C \times cos ( ( 2 π ) \int {f}_{c} ( τ ) d τ ) = C \times cos \{ ( 2 π ) ( \frac{1}{2} {α}_{C} \times {t}^{2} + {β}_{C} \times t + {φ}_{C} ) \} \qquad ( 4 )$$

C represents the amplitude of the pseudo signal of the interference wave, and can be freely determined. f_{C}(τ) represents the frequency characteristic of the noise signal. τ is a variable representing time. f_{C}(τ) is obtained by linear approximation of the instantaneous frequency f_{C} detected by the instantaneous phase detector 20 and the instantaneous frequency detector 21. The following formula (5) is a linear approximation equation of the instantaneous frequency f_{C}.

$$Formula 5 :$$

$${f}_{C} = {α}_{C} \times t + {β}_{C} \qquad ( 5 )$$

In formulas (3) and (4), f_{C}(τ) is replaced with the linear approximation equation of the instantaneous frequency f_{C} and integrated. φ_{C} represents an initial phase.

Operation of the first quadrature MIX 33 will next be described. In formula (1), V_{I} is expressed as the following formula (6) by integrating each of the first term representing the component of the noise signal and the second term representing the reception beat signal derived from the received desired wave. In formula (2), V_{Q} is expressed as the following formula (7) by integrating each of the first term representing the component of the noise signal and the second term representing the reception beat signal derived from the received desired wave. θ_{IR}(t) represents a time-phase characteristic of the noise signal. θ_{B}(t) represents a time-phase characteristic of the reception beat signal derived from the received desired wave.

$$Formula 6 :$$

$$\begin{matrix}{V}_{i} = A ( t ) \times sin ( ( 2 π ) \int ( {α}_{IR} \times τ + {B}_{IR} ) d τ ) + B \times sin ( \int ( {ω}_{B} ) d τ ) \\ = A ( t ) \times sin \{ ( 2 π ) ( \frac{1}{2} {α}_{IR} \times {t}^{2} + {β}_{IR} \times t + {φ}_{IR} ) \} + \\ B \times sin \{ ( {ω}_{B} \times t + {φ}_{B} ) \} \\ = A ( t ) \times sin ( {θ}_{IR} ( t ) ) + B \times sin ( {θ}_{B} ( t ) )\end{matrix} \qquad ( 6 )$$

$$Formula 7 :$$

$$\begin{matrix}{V}_{Q} = A ( t ) \times cos ( \int {ω}_{IR} ( τ ) d τ ) + B \times cos ( \int {ω}_{B} ( τ ) d τ ) \\ = A ( t ) \times cos ( {θ}_{IR} ( t ) ) + B \times cos ( {θ}_{B} ( t ) )\end{matrix} \qquad ( 7 )$$

From formulas (3) and (4), θ_{C}(t) representing the time-phase characteristic of the pseudo signal of the interference wave is expressed as the following formula (8) From formulas (3), (4), and (8), V_{C_I} and V_{C_Q}, representing the pseudo signals of the interference waves are respectively expressed as the following formulas (9) and (10).

$$Formula 8 :$$

$${θ}_{C} ( t ) = ( 2 π ) ( \frac{1}{2} {α}_{C} \times {t}^{2} + {β}_{C} \times t + {φ}_{C} ) \qquad ( 8 )$$

$$Formula 9 :$$

$${V}_{C , J} = C \times sin ( {θ}_{C} ( t ) ) \qquad ( 9 )$$

$$Formula 10 :$$

$$\begin{matrix}{V}_{C , Q} = C \times cos ( {θ}_{C} ( t ) ) & ( 10 )\end{matrix}$$

V′_{I} representing the output of MIX 23₁ is expressed as the following formula (11) using formulas (6) and (9).

$$Formula 11 :$$

$$\begin{matrix}{V}_{j}^{′} = {V}_{i} \times {V}_{C \_ I} \\ = \frac{A ( t ) C}{2} \{ - cos ( {θ}_{IR} ( t ) + {θ}_{C} ( t ) ) + cos ( {θ}_{IR} ( t ) - {θ}_{C} ( t ) ) \} + \\ \frac{BC}{2} \{ - cos ( {θ}_{B} ( t ) + {θ}_{C} ( t ) ) + cos ( {θ}_{B} ( t ) - {θ}_{C} ( t ) ) \}\end{matrix} \qquad ( 11 )$$

V″_{Q} representing the output of MIX 23₃ is expressed as the following formula (12) using formulas (7) and (10).

$$Formula 12 :$$

$$\begin{matrix}{V}_{Q}^{″} = {V}_{Q} \times {V}_{C \_ Q} \\ = \frac{A ( t ) C}{2} \{ cos ( {θ}_{IR} ( t ) + {θ}_{C} ( t ) ) + cos ( {θ}_{IR} ( t ) - {θ}_{C} ( t ) ) \} + \\ \frac{BC}{2} \{ cos ( {θ}_{B} ( t ) + {θ}_{C} ( t ) ) + cos ( {θ}_{B} ( t ) - {θ}_{C} ( t ) ) \}\end{matrix} \qquad ( 12 )$$

V″_{I} representing the output of MIX 23₄ is expressed as the following formula (13) using formulas (6) and (10).

$$Formula 13 :$$

$$\begin{matrix}{V}_{I}^{″} = {V}_{I} \times {V}_{C \_ Q} \\ = \frac{A ( t ) C}{2} \{ sin ( {θ}_{IR} ( t ) + {θ}_{C} ( t ) ) + sin ( {θ}_{IR} ( t ) - {θ}_{C} ( t ) ) \} + \\ \frac{BC}{2} \{ sin ( {θ}_{B} ( t ) + {θ}_{C} ( t ) ) + sin ( {θ}_{B} ( t ) - {θ}_{C} ( t ) ) \}\end{matrix} \qquad ( 13 )$$

V′_{Q} representing the output of MIX 23₂ is expressed as the following formula (14) using formulas (7) and (9).

$$Formula 14 :$$

$$\begin{matrix}{V}_{Q}^{′} = {V}_{Q} \times {V}_{C \_ I} \\ = \frac{A ( t ) C}{2} \{ sin ( {θ}_{IR} ( t ) + {θ}_{C} ( t ) ) - sin ( {θ}_{IR} ( t ) - {θ}_{C} ( t ) ) \} + \\ \frac{BC}{2} \{ sin ( {θ}_{B} ( t ) + {θ}_{C} ( t ) ) - sin ( {θ}_{B} ( t ) - {θ}_{C} ( t ) ) \}\end{matrix} \qquad ( 14 )$$

The output of the adder 25₁, that is, V″′_{I} representing an output voltage of the first quadrature MIX 33 is expressed as the following formula (15) using formulas (11) and (12).

$$Formula 15 :$$

$$\begin{matrix}{V}_{i}^{″} = {V}_{I}^{′} + {V}_{Q}^{″} = A ( t ) C \times cos ( {θ}_{IR} ( t ) - {θ}_{C} ( t ) ) + BC \times cos ( {θ}_{B} ( t ) - {θ}_{C} ( t ) ) & ( 15 )\end{matrix}$$

The output of the adder 25₂, that is, V″′_{Q} representing the output voltage of the first quadrature MIX 33 is expressed as the following formula (16) using formulas (13) and (14).

$$Formula 16 :$$

$$\begin{matrix}{V}_{Q}^{′′′} = {V}_{I}^{″} - {V}_{Q}^{′} = A ( t ) C \times sin ( {θ}_{IR} ( t ) - {θ}_{C} ( t ) ) + BC \times sin ( {θ}_{B} ( t ) - {θ}_{C} ( t ) ) & ( 16 )\end{matrix}$$

Here, in the interference wave pseudo signal source 32, in a case where α_{C}=α_{IR} and β_{C}=β_{IR} hold for α_{C} and β_{C} shown in formulas (3) and (4), θ_{C}(t) shown in formula (8) is expressed as the following formula (17).

$$Formula 17 :$$

$${θ}_{C} ( t ) = ( 2 π ) ( \frac{1}{2} {α}_{IR} \times {t}^{2} + {β}_{IR} \times t + {φ}_{C} ) \qquad ( 17 )$$

V″′_{I} shown in formula (15) is expressed as the following formula (18) using formula (17).

$$Formula 18 :$$

$$\begin{matrix}{V}_{I}^{′′′} = A ( t ) C \times cos ( {φ}_{IR} - {φ}_{C} ) + BC \times cos ( {θ}_{B} ( t ) - {θ}_{C} ( t ) ) & ( 18 )\end{matrix}$$

V″′_{Q} shown in formula (16) is expressed as the following formula (19) using formula (17).

$$Formula 19 :$$

$$\begin{matrix}{V}_{Q}^{′′′} = A ( t ) C \times sin ( {φ}_{IR} - {φ}_{C} ) + BC \times sin ( {θ}_{B} ( t ) - {θ}_{C} ( t ) ) & ( 19 )\end{matrix}$$

According to formulas (18) and (19), in the first quadrature MIX 33, the time variation component of θ_{IR} that is the component of the noise signal derived from the interference wave can be suppressed. However, the DC component remains in the first term of formula (18) and the first term of formula (19). The DC component is an error factor in the multiplication in the second quadrature MIX 35, and thus needs to be removed. Furthermore, the pseudo signal of the interference wave is superimposed on the reception beat signal derived from the received desired wave represented by each of the second term of formula (18) and the second term of formula (19). Thus, the pseudo signal superimposed on the reception beat signal derived from the received desired wave also needs to be removed.

Specific operation of the DC component suppressor 34 will next be described. The DC component suppressor 34 removes the DC components by detecting the DC components at the DC detectors 26₁ and 26₂ and by subtracting the DC components from V″′₁ and V″′_{Q} at the adders 27₁ and 27₂. The DC detectors 26₁ and 26₂ detect the DC components by, for example, a moving average method. The reception beat signal derived from the received desired wave represented by each of the second term of formula (18) and the second term of formula (19) is subjected to frequency modulation based on the pseudo signal of the interference wave. Thus, by applying low-pass filter processing using the moving average, the DC component suppressor 34 can remove the second term of formula (18) and extract only the first term of formula (18), and can remove the second term of formula (19) and extract only the first term of formula (19).

Using a moving average function as MA, the output of the adder 27₁, that is, V″″_{I} representing the output voltage of the DC component suppressor 34 is expressed as the following formula (20).

$$Formula 20 :$$

$$\begin{matrix}{V}_{I}^{′′′′} = {V}_{I}^{′′′} - MA ( {V}_{I}^{′′′} ) = Δ {V}_{DCERR \_ I} + BC \times cos ( {θ}_{B} ( t ) - {θ}_{C} ( t ) ) & ( 20 )\end{matrix}$$

The output of the adder 27₂, that is, V″″_{Q} representing the output voltage of the DC component suppressor 34 is expressed as the following formula (21).

$$Formula 21 :$$

$$\begin{matrix}{V}_{Q}^{′ ′ ′′} = {V}_{Q}^{′′′} - MA ( {V}_{Q}^{′′′} ) = Δ {V}_{DCERR \_ Q} + BC \times sin ( {θ}_{B} ( t ) - {θ}_{C} ( t ) ) & ( 21 )\end{matrix}$$

ΔV_{DCERR_I} and ΔV_{DCERR_Q} represent error components not suppressed by the DC component suppressor 34.

Operation of the second quadrature MIX 35 will next be described. The second quadrature MIX 35 removes the pseudo signal superimposed on the reception beat signal derived from the received desired wave from each of the second term of formula (20) and the second term of formula (21).

V′_{I2} representing the output of MIX 28₁ is expressed as the following formula (22) using formulas (9) and (20).

$$Formula 22 :$$

$$\begin{matrix}{V}_{I 2}^{′} = {V}_{I}^{′′′′} \times {V}_{C \_ I} = Δ {V}_{DCERR \_ I} C \times sin ( {θ}_{C} ( t ) ) + \frac{{BC}^{2}}{2} \{ sin ( {θ}_{B} ( t ) ) - sin ( {θ}_{B} ( t ) - 2 {θ}_{C} ( t ) ) \} & ( 22 )\end{matrix}$$

V″_{Q2} representing the output of MIX 28₃ is expressed as the following formula (23) using formulas (10) and (21).

$$Formula 23 :$$

$${V}_{Q 2}^{″} = {V}_{Q}^{′′′′} \times {V}_{C \_ Q} = Δ {V}_{DCERR \_ Q} C \times cos ( {θ}_{C} t ) ) + \frac{{BC}^{2}}{2} \{ sin ( {θ}_{B} ( t ) ) + sin ( {θ}_{B} ( t ) - 2 {θ}_{C} ( t ) ) \} \qquad ( 23 )$$

V″_{I2} representing the output of MIX 28₄ is expressed as the following formula (24) using formulas (10) and (20).

$$Formula 24 :$$

$$\begin{matrix}{V}_{I 2}^{″} = {V}_{I}^{′′′′} \times {V}_{C \_ Q} = Δ {V}_{DCERR \_ I} C \times cos ( {θ}_{C} t ) ) + \frac{{BC}^{2}}{2} \{ sin ( {θ}_{B} ( t ) ) + sin ( {θ}_{B} ( t ) - 2 {θ}_{C} ( t ) ) \} & ( 24 )\end{matrix}$$

V′_{Q2} representing the output of MIX 28₂ is expressed as the following formula (25) using formulas (9) and (21).

$$Formula 25 :$$

$${V}_{Q 2}^{′} = {V}_{Q}^{′′′′} \times {V}_{C \_ I} = Δ {V}_{DCERR \_ Q} C \times cos ( {θ}_{C} t ) ) + \frac{{BC}^{2}}{2} \{ - cos ( {θ}_{B} ( t ) ) + cos ( {θ}_{B} ( t ) - 2 {θ}_{C} ( t ) ) \} \qquad ( 25 )$$

The output of the adder 30₁, that is, V_{OI} representing the output voltage of the second quadrature MIX 35 is expressed as the following formula (26) using formulas (22) and (23).

$$Formula 26 :$$

$${V}_{OI} = {V}_{I 2}^{′} \times {V}_{Q 2}^{″} = {BC}^{2} \times sin ( {θ}_{B} ( t ) ) + Δ {V}_{DCERR \_ I} C \times sin ( {θ}_{C} ( t ) ) + Δ {V}_{DCERR \_ I} C \times cos ( {θ}_{C} ( t ) ) \qquad ( 26 )$$

The output of the adder 30₂, that is, V_{OQ} representing the output voltage of the second quadrature MIX 35 is expressed as the following formula (27) using formulas (24) and (25).

$$Formula 27 :$$

$${V}_{OQ} = {V}_{I 2}^{″} \times {V}_{Q 2}^{′} = {BC}^{2} \times cos ( {θ}_{B} ( t ) ) + Δ {V}_{DCERR \_ I} C \times cos ( {θ}_{C} ( t ) ) - Δ {V}_{DCERR \_ I} C \times sin ( {θ}_{C} ( t ) ) \qquad ( 27 )$$

In each of formulas (26) and (27), the first term represents the reception beat signal derived from the received desired wave. In each of formulas (26) and (27), the second term and the third term represent error components of the noise signal derived from the interference wave. The interference wave suppression device 36 can reduce the noise signal derived from the interference wave as a suppression rate of the DC component in the DC component suppressor 34 is higher. Thus, the radar apparatus 100 can obtain, by using the interference wave suppression device 36, the reception beat signal in which the reception beat signal derived from the received desired wave is a main component and the noise signal derived from the interference wave is suppressed.

The interference wave suppression device 36 outputs V_{OI} and V_{OQ}. The FFT processing unit 31 performs, based on V_{OI} and V_{OQ}, arithmetic processing for obtaining radar information such as the distance to the target, the relative velocity of the target, and the azimuth angle indicating the azimuth of the target.

FIG. 11 is an explanatory diagram illustrating an interference wave suppression effect of the interference wave suppression device 36 according to the first embodiment. FIG. 11 illustrates a graph representing a result of the fast Fourier transform in a case of “interference wave suppression ON” in which the suppression of the interference wave is performed, and a graph representing a result of the fast Fourier transform in a case of “interference wave suppression OFF” in which the suppression of the interference wave is not performed. In the graph illustrated in FIG. 11, a vertical axis represents relative power and a horizontal axis represents a frequency. The relative power is power normalized by a peak value of the reception beat signal derived from the received desired wave. The frequency modulation characteristic of each of the transmission wave, the received desired wave, and the received interference wave is as illustrated in FIG. 6.

As can be seen in FIG. 11, in the case of “interference wave suppression ON”, the result of the fast Fourier transform is stable as compared with the case of “interference wave suppression OFF”, and the SNR of the reception beat signal derived from the received desired wave is improved. As described above, the radar apparatus 100 can stably detect the target with high accuracy by suppressing the interference wave by using the interference wave suppression device 36.

According to the first embodiment, even when the difference between the frequency of the local signal and the frequency of the received interference wave matches the frequency in the IF band of the radar apparatus 100, the radar apparatus 100 can suppress only the noise signal superimposed on the reception beat signal derived from the received desired wave by using the interference wave suppression device 36. The radar apparatus 100 can prevent a decrease in the SNR of the reception beat signal derived from the received desired wave by suppressing the noise signal derived from the interference wave. Accordingly, the radar apparatus 100 has an effect capable of stably detecting the target with high accuracy.

The configurations described in the above embodiment are an example of the contents of the present disclosure. The configurations of the above embodiment may be combined with another known technique. Some of the configurations of the above embodiment may be omitted or changed without departing from the gist of the present disclosure.

### REFERENCE SIGNS LIST

1 reception antenna; 2 transmission antenna; 3 LNA; 4₁, 4₂, 23₁, 23₂, 23₃, 23₄, 28₁, 28₂, 28₃, 28₄ MIX; 5₁, 5₂ IFA; 6₁, 6₂ BBA; 7₁, 7₂ BPF; 8₁, 8₂ ADC; 9₁, 9₂ FIR filter; 10 VCO; 11 chirp signal generator; 12 PLL; 13 LF; 14 reference signal source; 15 PA; 16, 24, 29 phase shifter; 17 high frequency circuit; 18 baseband circuit; 19 MCU; 20 instantaneous phase detector; 21 instantaneous frequency detector; 22 interference wave pseudo signal generator; 25₁, 25₂, 27₁, 27₂, 30₁, 30₂ adder; 26₁, 26₂ DC detector; 31 FFT processing unit; 32 interference wave pseudo signal source; 33 first quadrature MIX; 34 DC component suppressor; 35 second quadrature MIX; 36 interference wave suppression device; 37 local unit; 50 processing circuitry; 51 input unit; 52 processor; 53 memory; 54 output unit; 100 radar apparatus.

1-2. (canceled)

3. A radar apparatus comprising:
a transceiver to output a transmission wave that is frequency-modulated, and to receive a reflected wave propagated by reflection of the transmission wave from a target and to output a reception signal; and
an interference wave suppression processor to separate, when an interference wave is received together with the reflected wave, a noise signal derived from the interference wave from the reception signal and to suppress the noise signal, the interference wave being a radio wave other than the reflected wave and being frequency-modulated in a mode different from a mode of the transmission wave,
wherein the interference wave suppression processor includes
an interference wave pseudo signal generator to generate a pseudo signal of the interference wave based on the reception signal in the case where the reflected wave and the interference wave are simultaneously received,
a first quadrature mixer to perform frequency conversion on the reception signal based on the pseudo signal and to suppress a time variation component of the noise signal, and
a direct current component suppressor to detect a direct current component generated in the first quadrature mixer and to suppress the direct current component detected.

4. The radar apparatus according to claim 3, wherein the interference wave suppression processor further includes a second quadrature mixer to perform frequency conversion on the reception signal based on the pseudo signal and to remove the pseudo signal by which the reception signal is multiplied in the first quadrature mixer.

5. The radar apparatus according to claim 3 wherein
the transceiver outputs a first reception beat signal and a second reception beat signal that are each the reception signal and have phases different from each other by 90 degrees, and
the interference wave pseudo signal generator generates the pseudo signal based on the first reception beat signal and the second reception beat signal in the case where the reflected wave and the interference wave are simultaneously received.

6. An interference wave suppression processor included in a radar apparatus to output a transmission wave that is frequency-modulated and to receive a reflected wave propagated by reflection of the transmission wave from a target, the interference wave suppression processor comprising:
an interference wave pseudo signal generator to generate a pseudo signal of an interference wave based on a reception signal in a case where the reflected wave and the interference wave are simultaneously received, the interference wave being a radio wave other than the reflected wave and being frequency-modulated in a mode different from a mode of the transmission wave;
a first quadrature mixer to perform frequency conversion on the reception signal based on the pseudo signal and to suppress a time variation component of a noise signal derived from the interference wave;
a direct current component suppressor to detect a direct current component generated in the first quadrature mixer and to suppress the direct current component detected; and
a second quadrature mixer to perform frequency conversion on the reception signal based on the pseudo signal and to remove the pseudo signal by which the reception signal is multiplied in the first quadrature mixer.

7. A radar apparatus comprising:
a transceiver to output a transmission wave that is frequency-modulated, and to receive a reflected wave propagated by reflection of the transmission wave from a target and to output a reception signal; and
an interference wave suppression processor to separate, when an interference wave is received together with the reflected wave, a noise signal derived from the interference wave from the reception signal and to suppress the noise signal, the interference wave being a radio wave other than the reflected wave and being frequency-modulated in a mode different from a mode of the transmission wave,
wherein the interference wave suppression processor includes
an interference wave pseudo signal generator to generate a pseudo signal of the interference wave based on the reception signal in the case where the reflected wave and the interference wave are simultaneously received,
a first quadrature mixer to perform frequency conversion on the reception signal based on the pseudo signal and to suppress a time variation component of the noise signal, and
a second quadrature mixer to perform frequency conversion on the reception signal based on the pseudo signal and to remove the pseudo signal by which the reception signal is multiplied in the first quadrature mixer.

8. The radar apparatus according to claim 4, wherein
the transceiver outputs a first reception beat signal and a second reception beat signal that are each the reception signal and have phases different from each other by 90 degrees, and
the interference wave pseudo signal generator generates the pseudo signal based on the first reception beat signal and the second reception beat signal in the case where the reflected wave and the interference wave are simultaneously received.

9. The radar apparatus according to claim 7, wherein
the transceiver outputs a first reception beat signal and a second reception beat signal that are each the reception signal and have phases different from each other by 90 degrees, and
the interference wave pseudo signal generator generates the pseudo signal based on the first reception beat signal and the second reception beat signal in the case where the reflected wave and the interference wave are simultaneously received.
